(19) United States
(12) Patent Application Publication
(10) Pub. No.: US 2016/0105662 A1
(43) Pub. Date: Apr. 14, 2016

(54) THREE-DIMENSIONAL GLASSES AND METHOD OF DRIVING THE SAME

(71) Applicant: Samsung Display Co., Ltd., Yongin-city (KR)

(72) Inventor: Myung-Hwan KIM, Seongnam-si (KR)

(21) Appl. No.: 14/659,558

(22) Filed: Mar. 16, 2015

(30) Foreign Application Priority Data
Oct. 8, 2014 (KR) 10-2014-0135529

(51) Int. Cl. H04N 13/04; G02B 27/22

(52) U.S. Cl. CPC H04N 13/044; G02B 27/2228; H04N 2213/008

(57) ABSTRACT

Three-dimensional (3D) glasses for a 3D display device including a glass unit including a left-eye glass and a right-eye glass, a sensor configured to sense a location of the 3D display device, a region determination unit configured to determine a transparent region of the glass unit on which a light emitted by the 3D display device is incident based on the location of the 3D display device, and a control unit configured to control the glass unit to pass external light through the transparent region and to block the external light on a blocking region other than the transparent region in the glass unit.

### CROSS REFERENCE TO RELATED APPLICATION

This application claims priority from and the benefit of Korean Patent Application No. 10-2014-0135529, filed on Oct. 8, 2014, which is hereby incorporated by reference for all purposes as if fully set forth herein.

### BACKGROUND

1. Field

Exemplary embodiments relate to a three-dimensional (3D) display device. Exemplary embodiments also relate to 3D glasses for the 3D display device, and a method of driving the 3D glasses.

2. Discussion of the Background

A 3D display device displays a 3D image using binocular disparity. Thus, the 3D display device provides a left-eye image to a left-eye of a viewer and a right-eye image to a right-eye of the viewer such that the binocular disparity is generated and the viewer perceives 3D depth of the 3D image. The 3D display device is classified as either a glasses type display device using special glasses or a non-glasses type display device not using the special glasses.

Specifically, the glasses type display device may be classified as a color filter type display device configured to divide and select images by using color filters complementary to each other; a polarization filter type display device to divide a left-eye image and a right-eye image by using an obscuration effect by a combination of orthogonal polarization elements; or a shutter glasses type display device to allow a user to perceive the 3D effect by alternately shading the left-eye image and the right-eye image in response to synchronization signals for projecting left-eye image signal and right-eye image signal on a screen. The 3D glasses for the glasses type display device passes external light through glasses, as well as a light emitted by the 3D display device, thereby decreasing 3D immersion of the viewer.

The above information disclosed in this Background section is only for enhancement of understanding of the background of the inventive concept, and, therefore, it may contain information that does not form the prior art that is already known in this country to a person of ordinary skill in the art.

### SUMMARY

Exemplary embodiments provide 3D glasses capable of increasing 3D immersion of a viewer.

Exemplary embodiments also provide a method of driving the 3D glasses.

Additional aspects will be set forth in the detailed description which follows and will, in part, be apparent from the disclosure, or may be learned by practice of the inventive concept.

An exemplary embodiment of the present invention discloses 3D glasses for a 3D display device, the 3D glasses including a glass unit including a left-eye glass and a right-eye glass, a sensor configured to sense a location of the 3D display device, a region determination unit configured to determine a transparent region of the glass unit on which a light emitted by the 3D display device is incident based on the location of the 3D display device, and a control unit configured to control the glass unit to pass external light through the transparent region and to block the external light on a blocking region other than the transparent region in the glass unit.

An exemplary embodiment of the present invention also discloses a method of driving 3D glasses, including recognizing a location of a 3D display device using a sensor, determining a transparent region of a glass unit on which a light emitted by the 3D display device is incident based on the location of the 3D display device, and controlling the glass unit to pass external light through the transparent region and to block the external light on a blocking region other than the transparent region in the glass unit.

The foregoing general description and the following detailed description are exemplary and explanatory and are intended to provide further explanation of the claimed subject matter.

### BRIEF DESCRIPTION OF THE DRAWINGS

The accompanying drawings, which are included to provide a further understanding of the inventive concept, and are incorporated in and constitute a part of this specification, illustrate exemplary embodiments of the inventive concept, and, together with the description, serve to explain principles of the inventive concept.

FIG. 1 is a block diagram illustrating 3D glasses according to an exemplary embodiment.

FIG. 2A and FIG. 2B are diagrams illustrating how the 3D glasses of FIG. 1 determine a transparent region and control the glass unit.

FIG. 3 is a cross-sectional view illustrating an example of a glass unit included in the 3D glasses of FIG. 1.

FIG. 4 is a cross-sectional view illustrating one example of a 3D lens of a left-eye glass included in a glass unit of FIG. 3.

FIG. 5 is a cross-sectional view illustrating another example of a 3D lens of a left-eye glass included in a glass unit of FIG. 3

FIG. 6 is a diagram illustrating how the 3D glasses of FIG. 1 update a transparent region.

FIG. 7 is a diagram illustrating how 3D glasses of FIG. 1 display additional information.

FIG. 8 is a flow chart illustrating a method of driving 3D glasses according to an exemplary embodiment.

### DESCRIPTION OF THE ILLUSTRATED EMBODIMENTS

In the following description, for the purposes of explanation, numerous specific details are set forth in order to provide a thorough understanding of various exemplary embodiments. It is apparent, however, that various exemplary embodiments may be practiced without these specific details or with one or more equivalent arrangements. In other instances, is well-known structures and devices are shown in block diagram form in order to avoid unnecessarily obscuring various exemplary embodiments.

In the accompanying figures, the size and relative sizes of layers, films, panels, regions, etc., may be exaggerated for clarity and descriptive purposes. Also, like reference numerals denote like elements.

When an element or layer is referred to as being “on,” “connected to,” or “coupled to” another element or layer, it may be directly on, connected to, or coupled to the other element or layer or intervening elements or layers may be present. When, however, an element or layer is referred to as being “directly on,” “directly connected to,” or “directly coupled to” another element or layer, there are no intervening elements or layers present. For the purposes of this disclosure, “at least one of X, Y, and Z” and “at least one selected from the group consisting of X, Y, and Z” may be construed as X only, Y only, Z only, or any combination of two or more of X, Y, and Z, such as, for instance, XYZ, XYY, YZ, and ZZ. Like numbers refer to like elements throughout. As used herein, the term “and/or” includes any and all combinations of one or more of the associated listed items.

Although the terms first, second, etc. may be used herein to describe various elements, components, regions, layers, and/or sections, these elements, components, regions, layers, and/or sections should not be limited by these terms. These terms are used to distinguish one element, component, region, layer, and/or section from another element, component, region, layer, and/or section. Thus, a first element, component, region, layer, and/or section discussed below could be termed a second element, component, region, layer, and/or section without departing from the teachings of the present disclosure.

Spatially relative terms, such as “beneath,” “below,” “lower,” “above,” “upper,” and the like, may be used herein for descriptive purposes, and, thereby, to describe one element or feature's relationship to another element(s) or feature(s) as illustrated in the drawings. Spatially relative terms are intended to encompass different orientations of an apparatus in use, operation, and/or manufacture in addition to the orientation depicted in the drawings. For example, if the apparatus in the drawings is turned over, elements described as “below” or “beneath” other elements or features would then be oriented “above” the other elements or features. Thus, the exemplary term “below” can encompass both an orientation of above and below. Furthermore, the apparatus may be otherwise oriented (e.g., rotated 90 degrees or at other orientations), and, as such, the spatially relative descriptors used herein interpreted accordingly.

The terminology used herein is for the purpose of describing particular embodiments and is not intended to be limiting. As used herein, the singular forms, “a,” “an,” and “the” are intended to include the plural forms as well, unless the context clearly indicates otherwise. Moreover, the terms “comprises,” comprising,” “includes,” and/or “including,” when used in this specification, specify the presence of stated features, integers, steps, operations, elements, components, and/or groups thereof, but do not preclude the presence or addition of one or more other features, integers, steps, operations, elements, components, and/or groups thereof.

Various exemplary embodiments are described herein with reference to sectional illustrations that are schematic illustrations of idealized exemplary embodiments and/or intermediate structures. As such, variations from the shapes of the illustrations as a result, for example, of manufacturing techniques and/or tolerances, are to be expected. Thus, exemplary embodiments disclosed herein should not be construed as limited to the particular illustrated shapes of regions, but are to include deviations in shapes that result from, for instance, manufacturing. For example, an implanted region illustrated as a rectangle will, typically, have rounded or curved features and/or a gradient of implant concentration at its edges rather than a binary change from implanted to non-implanted region. Likewise, a buried region formed by implantation may result in some implantation in the region between the buried region and the surface through which the implantation takes place. Thus, the regions illustrated in the drawings are schematic in nature and their shapes are not intended to illustrate the actual shape of a region of a device and are not intended to be limiting.

Unless otherwise defined, all terms (including technical and scientific terms) used herein have the same meaning as commonly understood by one of ordinary skill in the art to which this disclosure is a part. Terms, such as those defined in commonly used dictionaries, should be interpreted as having a meaning that is consistent with their meaning in the context of the relevant art and will not be interpreted in an idealized or overly formal sense, unless expressly so defined herein.

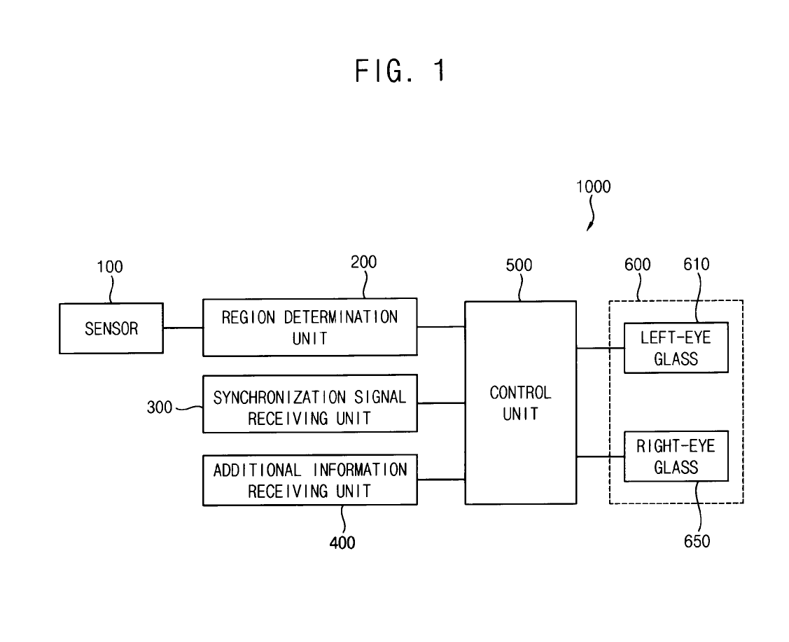

FIG. 1 is a block diagram illustrating 3D glasses according to an exemplary embodiment.

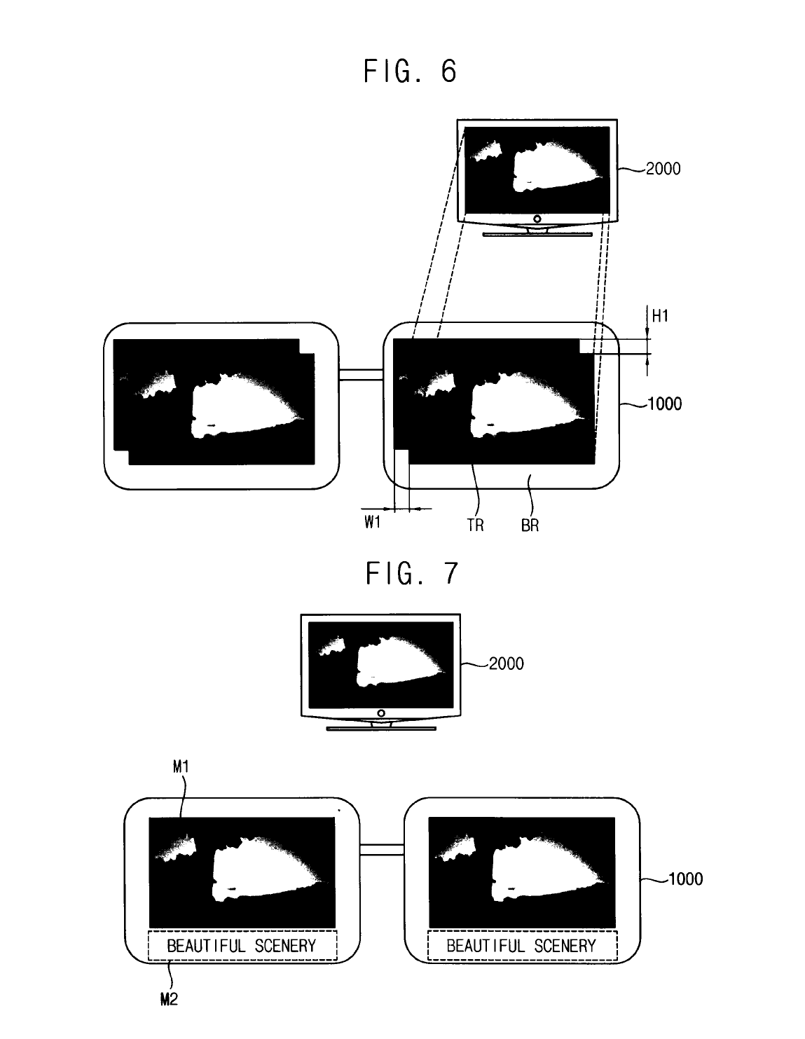

Referring to FIG. 1, three-dimensional (3D) glasses 1000 for a 3D display device 2000 (refer to FIGS. 6 and 7) may include a sensor 100, a region determination unit 200, a synchronization signal receiving unit 300, an additional information receiving unit 400, a control unit 500, and a glass unit 600. The 3D glasses 1000 may include a variety of devices for recognizing an imaged displayed by the 3D display device 2000 as a 3D image. For example, the 3D glasses 1000 may be applied to a head mounted display (HMD) device.

The sensor 100 may sense a location of the 3D display device. The sensor 100 may include a variety of devices for sensing the location of the 3D display device. For example, the sensor 100 may include a camera. For example, the 3D glasses 1000 may capture an image of the 3D display device 2000 using the camera and may sense the location of the 3D display device 2000 based on the captured image. Alternatively, the 3D glasses 1000 may capture an image of a pupil of a viewer using the camera and may sense the location and/or direction of the 3D display device based on the movement of the pupil. The sensor 100 may also include a laser sensor, radio frequency (RF) sensor, etc., for sensing the location of the 3D glasses 1000.

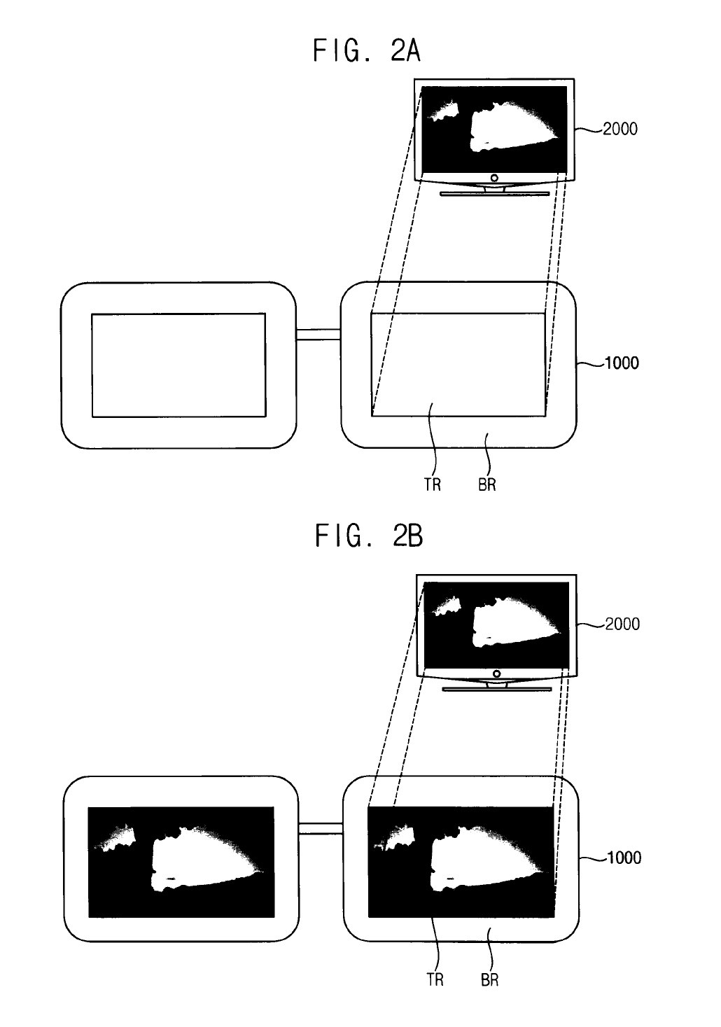

In addition, the sensor 100 may detect the movement of the viewer to determine whether it is necessary to update the transparent region TR (refer to FIGS. 2A and 2B). For example, the sensor 100 may include a vibration sensor, a horizontal level sensor, etc., for detecting the movement of the viewer.

The region determination unit 200 may determine a transparent region TR of the glass unit 600 on which a light emitted by the 3D display device 2000 is incident based on the location of the 3D display device 2000. The region determination unit 200 may receive location information of the 3D display device 2000. The region determination unit 200 may derive a location coordinate of the transparent region TR of the glass unit 600 based on the location information of the 3D display device 2000. For example, the region determination unit 200 may determine the transparent region TR more accurately using an adjustment value inputted from a user or a previous configuration value for the transparent region Tr. Because the transparent region TR can be changed by the movement of the viewer, it is needed to update the transparent region TR. For example, the region determination unit 200 may periodically update the transparent region TR at a predetermined period. For example, the region determination unit 200 may receive the location information of the 3D display device 2000 every second and may determine the transparent region TR based on the location information of the 3D display device 2000. In another example, the region determination unit 200 may update the transparent region TR when the movement of the viewer is detected. For example, when the vibration sensor of the 3D glasses 1000 detects the movement of the viewer, the region determination unit 200 may update the transparent region TR based on the location of the 3D display device 2000.

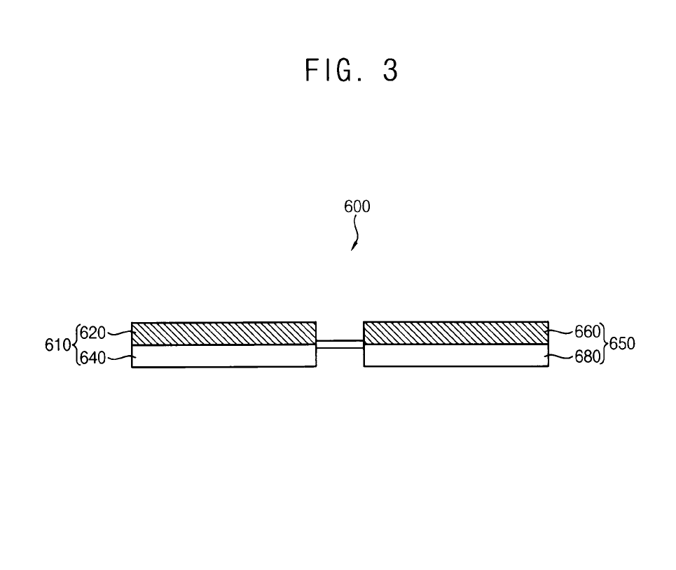

The synchronization signal receiving unit 300 may receive a synchronization signal from the 3D display device 2000. For example, the synchronization signal receiving unit 300 may receive a synchronization signal for a shutter operation from the 3D display device 2000 that is a shutter glasses type display device, thereby synchronizing the 3D glasses 1000 with the 3D display device 2000. In another example, when the glass unit 600 includes a transparent display panel 640, 680 (refer to FIG. 3), the synchronization signal receiving unit 300 may receive a synchronization signal for displaying additional information. Therefore, the additional image displayed by the transparent display panel 640, 680 may be synchronized with the image displayed by the 3D display device 2000.

The additional information receiving unit 400 may receive the additional information related to the image displayed by the 3D display device 2000. When the glass unit 600 includes a transparent display panel 640, 680, the additional information receiving unit 400 may receive the additional information related to the image displayed by the 3D display device 2000 from the 3D display device 2000, or from various peripheral devices connected to the 3D display device 2000. The additional information receiving unit 400 may provide the additional information to the control unit 500 to display the additional image corresponding to additional information on the transparent display panel 640, 680 of the glass unit 600. For example, when the 3D display device 2000 displays a movie, the information receiving unit 400 may receive the additional information, such as the title of the movie, the running time of the movie, the director of the movie, actors of the movie, a subtitle of the movie, etc.

The control unit 500 may control the glass unit 600 to pass external light through the transparent region TR and to block the external light on a blocking region BR (refer to FIGS. 2A, 2B) other than the transparent region TR in the glass unit 600. Here, the external light refers to a light incident from the outside of the 3D glasses 1000 to the viewer passing through the 3D glasses 1000. The control unit 500 may receive information of the transparent region TR from the region determination unit 200. The control unit 500 may provide a control signal to the glass unit 600 to block the external light on a blocking region BR of the glass unit 600.

In addition, when the glass unit 600 includes a transparent display panel 640, 680, the control unit 500 may perform a role as a controller for controlling the transparent display panel 640, 680. For example, the control unit 500 may receive the additional information related to the image displayed by the 3D display device 2000 from the additional information receiving unit 400. The control unit 500 may generate image data of the additional image using received additional information, and may provide the image data and a control signal for displaying the additional image on the glass unit 600.

The control unit 500 may receive the synchronization signal from the synchronization signal receiving unit 300. The control unit 500 may generate a control signal of the glass unit 600 based on the synchronization signal. For example, when the 3D display device 2000 is a shutter glasses type display device, the control unit 500 may receive the synchronization signal for the shutter operation; may generate a control signal of the shutter operation for displaying the 3D image; and may provide the generated control signal to the glass unit 600. Also, when the glass unit 600 includes the transparent display panel 640, 680, the control unit 500 may receive a synchronization signal for displaying the additional information, and may generate a control signal based on the synchronization signal for displaying the additional image synchronized with the image displayed by the 3D display device 2000 on the transparent display panel 640, 680.

The glass unit 600 may include a left-eye glass 610 and a right-eye glass 650. The glass unit 600 may provide left-eye image to a left-eye of the viewer and right-eye image to a right-eye of the viewer such that the binocular disparity is generated and the viewer perceives 3D depth of the 3D image.

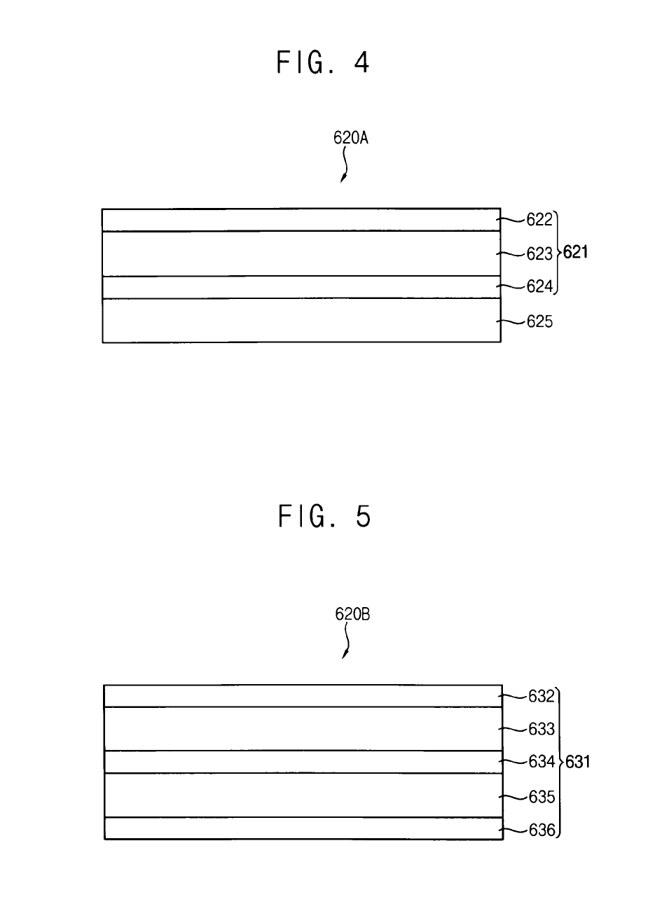

Each of the left-eye glass 610 and the right-eye glass 650 may include a 3D lens 620, 660 (refer to FIG. 3). The 3D lens 620, 660 may pass the external light incident on the transparent region TR, and may block the external light incident on the blocking region BR. For example, the 3D lens 620, 660 may include a polarization part 621 and a blocking part 625 (refer to FIG. 4). The polarization part 621 may polarize the light emitted by the 3D display device 2000 such that an image displayed by the 3D display device 2000 is recognized as a 3D image. The blocking part 625 may block the external light incident on the blocking region BR. In another example, the 3D lens 620, 660 may include a shutter part 631 (refer to FIG. 5). The shutter part 631 may selectively transmit or shut off the light emitted by the 3D display device 2000 incident on the transparent region TR such that an image displayed by the 3D display device 2000 is recognized as a 3D image, and may block the external light incident on the blocking region BR. Further, each of the left-eye glass 610 and the right-eye glass 650 may further include the transparent display panel 640, 680. The transparent display panel 640, 680 may be located on the 3D lens 620, 660. The transparent display panel 640, 680 may display the additional image. Hereinafter, the glass unit 600 will be described in detail with reference to FIG. 3 through FIG. 5.

In addition, the 3D glasses 1000 may further include a light shield, which may increase the 3D immersion of the viewer.

Therefore, the 3D glasses 1000 may pass the external light incident on the transparent region TR and may block the external light incident on the blocking region BR, thereby increasing the 3D immersion of the viewer. In addition, the 3D glasses 1000 may include a transparent display panel 640, 680 to provide additional information to the user with high visibility.

FIGS. 2A and 2B are diagrams illustrating how the 3D glasses of FIG. 1 determine a transparent region TR and control the glass unit 600.

Referring to FIGS. 2A and 2B, the 3D glasses 1000 may pass external light incident on the transparent region TR and may block the external light incident on the blocking region BR.

As shown in FIG. 2A, the 3D glasses 1000 may determine the transparent region TR on which a light emitted by the 3D display device 2000 is incident based on location of the 3D display device 2000.

The 3D glasses 1000 may determine the transparent region TR using the sensor, which may include a camera. For example, the camera may capture an image of the 3D display device 2000 and may recognize the location of the 3D display device 2000 by analyzing the captured image by the camera. For example, the 3D glasses 1000 may recognize a 3D display device region from the captured image and may estimate location and/or direction of the 3D display device 2000 using size and angle of the 3D display device region. The 3D glasses 1000 may determine the transparent region TR of the glass unit corresponding to the location of the 3D display device 2000. In another t, the camera may capture an image of a pupil of a viewer to sense the location of the 3D display device 2000. For example, the 3D glasses 1000 may sense the movement of the pupil using the camera, and may determine the transparent TR based on a movement of the viewer's eyes.

The 3D glasses 1000 may determine the transparent region TR using the laser sensor and a RF sensor. For example, the transparent region TR of the 3D display device 2000 may be determined by sending or receiving a laser signal having predetermined pattern.

As shown in FIG. 2B, the 3D glasses 1000 may pass the external light incident on the transparent region TR, and may block the external light incident on the blocking region BR.

The 3D glasses 1000 may pass a light emitted by the 3D display device 2000 through the transparent region TR by performing the operation of the ordinary 3D glasses 1000. For example, the 3D glasses 1000 may divide into the left-eye image into the right-eye image by using an obscuration effect including a combination of orthogonal polarization elements (i.e., polarization glasses method). In another example, the 3D glasses 1000 may alternatively shade left-eye image and right-eye image in response to synchronization signals for being synchronized with the 3D display device 2000 (i.e., shutter glasses method). Therefore, the 3D glasses 1000 may provide left-eye image to the left-eye of the viewer and right-eye image to the right-eye of the viewer on the transparent region TR.

FIG. 3 is a cross-sectional view illustrating an example of the glass unit 600 included in the 3D glasses of FIG. 1.

Referring to FIG. 3, the glass unit 600 may include a left-eye glass 610 and a right-eye glass 650.

The left-eye glass 610 may include a left-eye 3D lens 620. The left-eye 3D lens 620 may pass the external light incident on the transparent region TR and may block the external light incident on the blocking region BR.

For example, the left-eye 3D lens 620 may include a polarization part 621 and a blocking part 625. The polarization part 621 may polarize the light emitted by the 3D display device 2000 such that an image displayed by the 3D display device 2000 is recognized as a 3D image. The blocking part 625 may block the external light incident on the blocking region BR. Hereinafter, the left-eye 3D lens 620 including the polarization part 621 and the blocking part 625 will be described in detail with reference to the FIG. 4.

In another example, the left-eye 3D lens 620 may include a shutter part 631. The shutter part 631 may selectively transmit or shut off the light emitted by the 3D display device incident on the transparent region such that an image displayed by the 3D display device is recognized as a 3D image, and may block the external light incident on the blocking region. Hereinafter, the left-eye 3D lens 620 including the shutter part 631 will be described in detail with reference to the FIG. 5.

In addition, the left-eye glass 610 may further include a left-eye transparent display panel 640. The left-eye transparent display panel 640 may be located on the left-eye 3D lens 620. The left-eye transparent display panel 640 may display an additional image. The left-eye transparent display panel 640 may utilize a variety of structures capable of providing situation information to the viewer by passing the external light and providing display information to the viewer by displaying the image. For example, the transparent display panel 640 may include a pixel region on which the image is displayed and a transmitting region through which the external light passes.

The right-eye glass 650 may include a right-eye 3D lens 660. The right-eye 3D lens 660 may pass the external light incident on the transparent region TR and may block the external light incident on the blocking region BR. In addition, the right-eye glass 650 may further include a right-eye transparent display panel 680. The right-eye transparent display panel 680 may be located on the right-eye 3D lens 660. The right-eye transparent display panel 680 may display an additional image. Because the right-eye glass 650 is substantially the same as the left-eye glass 610, except that the right-eye glass 650 passes the right-eye image instead of the left-eye image, duplicated descriptions will be omitted.

FIG. 4 is a cross-sectional view illustrating one example of a 3D lens 620 of a left-eye glass 610 included in a glass unit of FIG. 3.

Referring to FIG. 4, the left-eye 3D lens 620A included in the left-eye glass 610 may include a left-eye polarization part 621 and a left-eye blocking part 625.

The left-eye polarization part 621 may divide left-eye image and right-eye image by using an obscuration effect by a combination of orthogonal polarization and may pass only the left-eye image. For example, the left-eye polarization part 621 may include a left-eye phase delay plate 622, a left-eye substrate 623, and a first left-eye polarizing plate 624.

The left-eye phase delay plate 622 may divide left-eye image and right-eye image that are polarized in different directions, and may adjust a polarization state to pass only the left-eye image. For example, the left-eye phase delay plate 622 included in the left-eye glass or the right-eye phase delay plate included in the right-eye glass may be a ¼ wavelength plate. For example, the left-eye phase delay plate 622 may adjust the polarization state by +¼, and the right-eye phase delay plate may adjust the polarization state by −¼. Therefore, the 3D display device 2000 may display a 3D image including the left-eye image and the right-eye image that are polarized in different directions. The left-eye phase delay plate 622 may pass the left-eye image and the left-eye image may be polarized in a direction parallel with the first left-eye polarizing plate 624.

The left-eye substrate 623 may include a transparent material. For example, the left-eye substrate 623 may include the transparent material that does not cause a phase difference regardless of the polarization direction. For example, the left-eye substrate 623 may include glass, transparent film, etc. In another example, the left-eye substrate 623 may include a material having a predetermined refractive index to correct a vision of the viewer. For example, the left-eye substrate 623 may include a convex lens or a concave lens.

The first left-eye polarizing plate 624 may pass only a parallel linearly polarized light among a light passing through the left-eye phase delay plate 622. Therefore, the left-eye image passing through the left-eye phase delay plate 622 may be linearly polarized in parallel with the first left-eye polarizing plate 624 and may pass through the first left-eye polarizing plate 624. On the other hand, the right-eye image passing through the left-eye phase delay plate 622 may be linearly polarized orthogonal to the first left-eye polarizing plate 624 and may not be passed through the first left-eye polarizing plate 624.

However, the structure of the left-eye polarization part 621 is not limited thereto. Thus, the left-eye polarization part 621 may have a variety of structures capable of dividing the image into the left-eye image and the right-eye image such that an image displayed by the 3D display device is recognized as a 3D image.

The left-eye blocking part 625 may block the external light incident on the blocking region. For example, the left-eye blocking part 625 may include a first left-eye electrode, a left-eye liquid crystal (LC) layer, a second left-eye electrode, and a second left-eye polarizing plate. For example, the left-eye blocking part 625 may control the first left-eye electrode and the second left-eye electrode such that an electric field is not formed in the left-eye LC layer corresponding to the transparent region TR, thereby passing the left-eye image on the transparent region TR. On the other hand, the left-eye blocking part 625 may control the first left-eye electrode and the second left-eye electrode such that the electric field is formed in the left-eye LC layer corresponding to the blocking region BR, thereby blocking the left-eye image on the blocking region BR.

However, a structure of the left-eye blocking part 625 is not limited thereto. Thus, the left-eye blocking part 625 may have a variety of structures capable of partially blocking the external light.

Because the right-eye 3D lens corresponding to the left-eye 3D lens 620A is substantially the same as the left-eye 3D lens 620A, except that the right-eye image only passes using a right-eye phase delay plate, duplicated descriptions will be omitted.

FIG. 5 is a cross-sectional view illustrating another example of a 3D lens 620 of a left-eye glass included in a glass unit 600 of FIG. 3

Referring to FIG. 5, the left-eye 3D lens 620B included in the left-eye glass 610 may include a left-eye shutter part 631. The left-eye shutter part 631 may selectively transmit or shut off the light emitted by the 3D display device 2000 incident on the transparent region TR such that an image displayed by the 3D display device 2000 is recognized as a 3D image, and may block the external light incident on the blocking region BR. For example, the left-eye shutter part 631 may include a first left-eye polarizing plate 632, a first left-eye substrate 633, a left-eye shutter LC layer 634, a second left-eye substrate 635, and a second left-eye polarizing plate 636.

The first left-eye substrate 633 may include a variety of transparent materials that do not cause a phase difference regardless of the polarization direction. The first left-eye substrate 633 may include a first electrode (not shown).

The second left-eye substrate 635 may be opposite to the first left-eye substrate 633. The second left-eye substrate 635 may include a variety of transparent materials that do not cause a phase difference regardless of the polarization direction. The second left-eye substrate 635 may include a second electrode (not shown) opposing the first electrode.

The first left-eye polarizing plate 632 may be disposed on the first left-eye substrate 633. A light emitted by a 3D display device 2000 may be linearly polarized in parallel with the first left-eye polarizing plate 632 by passing though the first left-eye polarizing plate 632.

The second left-eye polarizing plate 636 may be disposed on the second left-eye substrate 635. The first left-eye polarizing plate 632 and the second left-eye polarizing plate 636 may be disposed to be orthogonal to each other.

The left-eye shutter LC layer 634 may be disposed between the first electrode and the second electrode to change a polarization state of the light according to whether an electric field is formed therebetween. For example, when the first electrode and the second electrode are controlled to form the electric field, the left-eye shutter LC layer 634 may not change the polarization state of the image, thereby blocking the image displayed by the 3D display device. On the other hand, when the first electrode and the second electrode are controlled to not form the electric field, the left-eye shutter LC layer 634 may change the polarization state of the image, thereby passing the image displayed by the 3D display device through the left-eye shutter LC layer 634. Therefore, the first electrode and the second electrode may be controlled to pass the left-eye image and to block the right-eye image.

However, a structure of the left-eye shutter part 631 is not limited thereto. Thus, left-eye shutter part 631 may have a variety of structures capable of blocking only the right-eye image on the transparent region and blocking all external light on the blocking region.

Because the right-eye 3D lens corresponding to the left-eye 3D lens 620B is substantially the same as the left-eye 3D lens 620B, except that the right-eye image only passes and the left-eye image is blocked using a right-eye shutter part, duplicated descriptions will be omitted.

FIG. 6 is a diagram illustrating how 3D glasses of FIG. 1 update a transparent region TR.

Referring to FIG. 6, the 3D glasses 1000 may update a transparent region TR based on the location of a 3D display device 2000. The transparent region TR may be changed by a movement of the viewer. When the transparent region TR is changed, a portion of a light emitted by the 3D display device 2000 may be blocked on a blocking region BR. Therefore, it is necessary to update the transparent region TR based on the location of a 3D display device 2000.

For example, the transparent region TR may be periodically updated at a predetermined period. The region determination unit 200 included in the 3D glasses 1000 may periodically receive the location information of the 3D display device 2000 from a sensor, and may then update the transparent region TR based on the location of the 3D display device 2000. For example, the region determination unit 200 may receive the location information of the 3D display device 2000 from the sensor every second. The region determination unit 200 may update the transparent region TR based on the location of the 3D display device 2000. The region determination unit 200 may adjust the transparent region TR by W1 in the horizontal direction and by H1 in the vertical direction not to block the portion of the light emitted by the 3D display device 2000.

In another example, the transparent region TR may be updated when the movement of the viewer is detected. The region determination unit 200 included in the 3D glasses 1000 may update the transparent region TR based on the location of the 3D display device 2000 when the movement of the viewer is detected by the sensor. For example, when the vibration sensor detects the movement of the viewer greater than threshold value, the region determination unit 200 may receive the location information of the 3D display device 2000. The region determination unit 200 may update the transparent region TR based on the location of the 3D display device 2000. The region determination unit 200 may adjust the transparent region TR by W1 in the horizontal direction and by H1 in the vertical direction not to block the portion of the light emitted by the 3D display device 2000.

Therefore, the 3D glasses 1000 may automatically adjust the transparent region TR based on the location of the 3D display device 2000 to trace the location of the 3D display device 2000 and to pass the light emitted by the 3D display device 2000 through the transparent region TR.

FIG. 7 is a diagram illustrating how the 3D glasses of FIG. 1 display additional information.

Referring to FIG. 7, the 3D glasses 1000 may include a transparent display panel 640, 680, and may display additional image having additional information on the transparent display panel 640, 680.

Each of the left-eye glass 610 and the right-eye glass 650 included in the 3D glasses 1000 may include the transparent display panel 640, 680, respectively, displaying the additional image M2. The 3D glasses 1000 may include an additional information receiving unit 400 configured to receive the additional information from the 3D display device 2000 or peripheral devices connected to the 3D display device 2000. The 3D glasses 1000 may generate the additional image M2 based on the addition information and may display the additional image M2 on the transparent display panel 640, 680.

For example, the transparent display panel 640, 680 may display the additional image M2 at least in part on the blocking region BR. The transparent display panel 640, 680 may display the additional image M2 on the blocking region BR on which the external light is blocked to increase the visibility of the additional image M2. For example, the additional image M2 may be synchronized to the image M1 displayed by the 3D display device 2000. The transparent display panel 640, 680 may display the additional image M2 that is synchronized with the image M1 displayed by the 3D display device 2000, thereby providing the additional information related to the image M1 displayed by the 3D display device 2000 to the viewer.

For example, when the 3D display device 2000 displays a movie, the 3D glasses 1000 may receive the subtitle of the movie as the additional information of the image M1 displayed by the 3D display device 2000. The 3D glasses 1000 may generate the additional image M2 using the subtitle of the movie. The 3D glasses 1000 may pass the image M1 displayed by the 3D display device 2000 through the transparent region TR and display the additional image M2 at least in part on the blocking region BR.

Therefore, the 3D glasses 1000 may display the additional image M2 having the additional information related to the image M1 displayed by the 3D display device 2000 using the transparent display panel 640, 680, thereby providing the additional information to the user with high visibility.

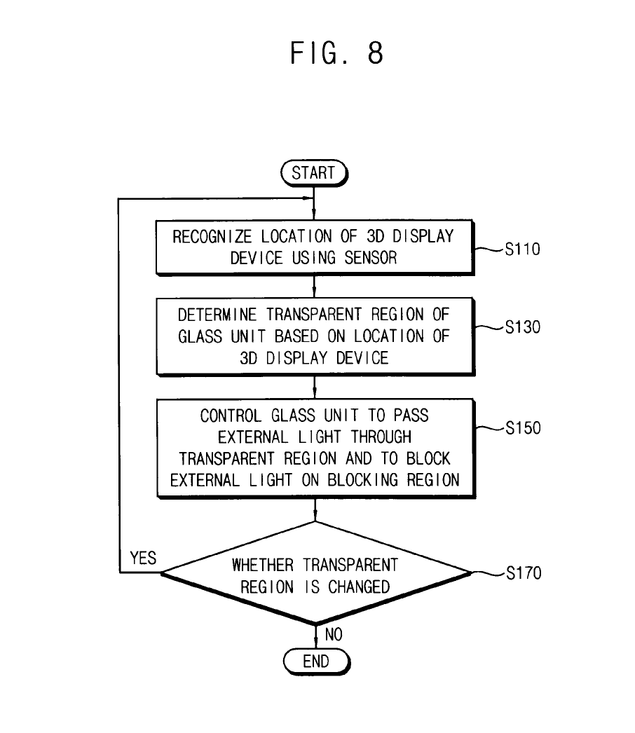

FIG. 8 is a flow chart illustrating a method of driving 3D glasses according to an exemplary embodiment.

Referring to FIG. 8, the method of driving 3D glasses may pass external light through the transparent region TR and block the external light on a blocking region BR, thereby increasing 3D immersion of the viewer.

A location of a 3D display device 2000 may be recognized using a sensor in Step S110. For example, the sensor may include a camera, and the camera may capture an image of the 3D display device 2000 to sense the location of the 3D display device 2000. Alternatively, the camera may capture an image of a pupil of the viewer to sense the location of the 3D display device 2000. Because the method of recognizing the location of the 3D display device is described above, duplicated descriptions will be omitted.

A transparent region TR of a glass unit 600 on which a light emitted by the 3D display device is incident may be determined based on the location of the 3D display device 2000 in Step S130. A location coordinate of the transparent region TR of the glass unit 600 may be derived based on the location of the 3D display device 2000. For example, the transparent region TR may be determined more accurately using an adjustment value inputted from the user or a previous configuration value for the transparent region TR.

The glass unit 600 may be controlled to pass external light through the transparent region TR and to block the external light on a blocking region BR other than the transparent region TR in the glass unit in Step S 150. Thus, the light emitted by the 3D display device 2000 is adjusted on the transparent region TR such that an image displayed by the 3D display device 2000 is recognized as a 3D image. Also, the all external light incident on the blocking region BR is blocked, thereby increasing 3D immersion of the viewer. For example, the light emitted by the 3D display device 2000 is polarized by a polarization part 621 such that an image displayed by the 3D display device 2000 is recognized as a 3D image. The external light incident on the blocking region BR is blocked by a blocking part 625. In another example, the light emitted by the 3D display device 2000 incident on the transparent region TR may be selectively transmit or shut off such that an image displayed by the 3D display device 2000 is recognized as a 3D image, and the external light incident on the blocking region BR is blocked by a shutter part 631. Because the method of controlling the glass unit 600 and the structure of the glass unit 600 are described above, duplicated descriptions will be omitted.

It is determined whether the transparent region TR is changed in Step S170. The transparent region TR may be changed by the movement of the viewer. When the transparent region TR is changed, a portion of a light emitted by the 3D display device 2000 may be blocked on a blocking region BR. Therefore, the transparent region TR is updated based on the location of a 3D display device 2000. For example, the transparent region TR may be periodically updated at a predetermined period. In another example, the transparent region TR may be updated when the movement of the viewer is detected. Because the method of updating the transparent region TR is described above, duplicated descriptions will be omitted.

Although the disclosed exemplary embodiments disclose a shutter glasses type display device or a polarization filter type display device, a variety of other types of display devices may be used.

The present inventive concept may be applied to a variety of devices performing a role as 3D glasses. For example, the present inventive concept may be applied to normal 3D glasses, a head mounted display (HMD), a wearable electronic device, etc.

In summary, the 3D glasses and the method of driving the 3D glasses according to exemplary embodiments increase 3D immersion of a viewer by passing external light incident on the transparent region and blocking the external light incident on a blocking region. In addition, the 3D glasses may include a transparent display panel to provide additional information to the user with high visibility.

Although certain exemplary embodiments and implementations have been described herein, other embodiments and modifications will be apparent from this description. Accordingly, the inventive concept is not limited to such embodiments, but rather to the broader scope of the presented claims and various obvious modifications and equivalent arrangements.

What is claimed is:

1. Three-dimensional (3D) glasses for a 3D display device, the 3D glasses comprising:
a glass unit comprising a left-eye glass and a right-eye glass;
a sensor configured to sense a location of the 3D display device;
a region determination unit configured to determine a transparent region of the glass unit on which a light emitted by the 3D display device is incident based on the location of the 3D display device; and
a control unit configured to control the glass unit to pass external light through the transparent region and to block the external light on a blocking region other than the transparent region in the glass unit.

2. The 3D glasses of claim 1, further comprising a synchronization signal receiving unit configured to receive a synchronization signal from the 3D display device,
wherein the control unit is configured to control the glass unit using the synchronization signal.

3. The 3D glasses of claim 1, wherein each of the left-eye glass and the right-eye glass comprises a 3D lens configured to pass the external light incident on the transparent region, and to block the external light incident on the blocking region.

4. The 3D glasses of claim 3, wherein the 3D lens comprises:
a polarization part configured to polarize the light emitted by the 3D display device such that an image displayed by the 3D display device is recognized as a 3D image; and
a blocking part configured to block the external light incident on the blocking region.

5. The 3D glasses of claim 3, wherein the 3D lens comprises a shutter part configured to selectively transmit or shut off the light emitted by the 3D display device incident on the transparent region such that an image displayed by the 3D display device is recognized as a 3D image, and to block the external light incident on the blocking region.

6. The 3D glasses of claim 3, wherein each of the left-eye glass and the right-eye glass further comprises a transparent display panel located on the 3D lens, the transparent display panel configured to display an additional image.

7. The 3D glasses of claim 6, further comprising an additional information receiving unit configured to receive an additional information related to an image displayed by the 3D display device,
wherein the transparent display panel is configured to display the additional image generated using the additional information.

8. The 3D glasses of claim 7, wherein the transparent display panel is configured to display the additional image at least in part on the blocking region.

9. The 3D glasses of claim 7, wherein the additional image is synchronized to the image displayed by the 3D display device.

10. The 3D glasses of claim 1, wherein the sensor comprises a camera.

11. The 3D glasses of claim 10, wherein the camera is configured to capture an image of the 3D display device to sense the location of the 3D display device.

12. The 3D glasses of claim 10, wherein the camera is configured to capture an image of a pupil of a viewer to sense the location of the 3D display device.

13. The 3D glasses of claim 1, wherein the region determination unit is configured to periodically update the transparent region at a predetermined period.

14. The 3D glasses of claim 1, wherein the region determination unit is configured to update the transparent region when a movement of a viewer is detected.

15. A method of driving three-dimensional (3D) glasses comprising:
recognizing a location of a 3D display device using a sensor;
determining a transparent region of a glass unit on which a light emitted by the 3D display device is incident based on the location of the 3D display device; and
controlling the glass unit to pass external light through the transparent region and to block the external light on a blocking region other than the transparent region in the glass unit.

16. The method of claim 15, wherein the sensor comprises a camera.

17. The method of claim 16, wherein recognizing the location of the 3D display device comprises capturing an image of the 3D display device using the camera.

18. The method of claim 16, wherein recognizing the location of the 3D display device comprises capturing an image of a pupil of a viewer using the camera.

19. The method of claim 15, wherein the transparent region is periodically updated at a predetermined period.

20. The method of claim 15, wherein the transparent region is updated when a movement of a viewer is detected.
